(19) United States
(12) Patent Application Publication
(10) Pub. No.: US 2006/0150784 A1
(43) Pub. Date: Jul. 13, 2006

(54) Double end drive tool

(76) Inventor: Chih Ching Hsieh, Fongyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/031,041

(22) Filed: Jan. 10, 2005

(51) Int. Cl. B25B 23/16; B25B 13/00; B25G 1/00

(52) U.S. Cl. 81/125.1; 81/177.7; 81/177.8

(57) ABSTRACT

A double head drive tool with each head serving as a moment of force for the other end includes a handle having its both ends respectively provided with a pivoting part; each pivoting part being extended a connection section; each connection section being adapted with a work piece turning member; a locking channel and a longitudinal being provided to the work piece turning member; a work hole being provided on the pivoting part of the handle of the drive tool; and a locking member penetrating the work hole and the through hole to lock the work piece turning member.

### BACKGROUND OF THE INVENTION

(a) Field of the Invention

The present invention is related to a double end drive tool that each end serving the moment of force for the other end, and more particularly, to a construction of a tool having both ends respectively provided with a connection section to receive insertion of members of different types for turning work pieces to provide multiple purposes.

(b) Description of the Prior Art

As illustrated in FIG. 9 of the accompanying drawings, a single rock arm drive tool of the prior has provided on one side of the handle 6 of the drive tool a drive 61 to be adapted with an open-end wrench 62. A pivoting hole 63 is provided to the drive 61 to permit a locking member 64 to penetrate through it to lock the open-end wrench. The construction described above though provides the function of tightening up a nut, the middle section of the locking member 64 for being engaged in serration with the open-end wrench 62 is vulnerable to cause abnormal tear and wear to the pivoting hole 63 of the drive 61 as illustrated in FIG. 10. After the use for a longer time, the serration between the middle section of the locking member 64 will get deformed or broken up due to friction for a long time. Furthermore, the single rock arm tool needs comparatively larger workspace. In an environment the tooling machine gets complicated by day, the service space is relatively getting smaller to frustrate the utility of the single rock arm tool that prevents its use from a smaller space.

Another type of double rock arm socket tool as illustrated in FIG. 11 has both ends of a handle 71 respectively disposed with a drive 71 to be adapted with a socket 72. A pivoting hole 73 is provided to the drive 71 for a locking member 74 to penetrate through for locking up the socket 72 so that the double rock arm socket tool is capable of tightening up a nut. However, a center point must be first determined for the pivoting hole 73 to facilitate the drill job. After the drill process, the pivoting hole 73 is vulnerable to reaming as illustrated in FIG. 12. Furthermore, the shorter moment of force limits the double rock arm socket tool to the use adapted with the socket 72. For being restricted by the insertion length of the socket 72 and the size of a bolt, it is usually difficult to connect the bolt by insertion or change the size of socket 72 to compromise the bolt. The shorter moment of force of the double rock arm socket tool takes greater force to pull a work piece. Again, the utility of the double rock arm socket tool is frustrated.

### SUMMARY OF THE INVENTION

The primary purpose of the present invention is to provide a double end drive tool that each end could serve the moment of force for the other end to permit its use in a confined space and free of deformation and reaming between the handle of the tool and the locking member by providing respectively on both ends of the handle of the tool a member to turn a work piece, and a locking member to pivot the turning member into a connection section member for yielding longer moment of force.

To achieve the purpose, the present invention includes a handle of a drive tool, a pivoting part is each provided to both ends of the handle, and each pivoting part is disposed with a connection section adapted with a member to turn the work piece. A locking channel and a longitudinal through hole are provided to each work piece turning member, and a work hole is disposed on the pivoting part on the handle of the drive tool for a locking member to lock up the work piece turning member via the through hole and the work hole.

### BRIEF DESCRIPTION OF THE DRAWINGS

FIG. 1 is a perspective view of a first preferred embodiment of the present invention.

FIG. 2 is a schematic view showing the relation between a work piece turning member and a locking member of the first preferred embodiment of the present invention.

FIG. 3 is a schematic view showing the first preferred embodiment of the present invention in use.

FIG. 4 is a perspective view of a second preferred embodiment of the present invention.

FIG. 5 is a perspective view of a third preferred embodiment of the present invention.

FIG. 6 is a perspective view showing a handle and a work piece turning member of the present invention.

FIG. 7 is another perspective view showing a handle and a work piece turning member of the present invention.

FIG. 8 is another perspective view yet showing a handle and a work piece turning member of the present invention.

FIG. 9 is a schematic view showing an appearance of an open-end wrench of the prior art.

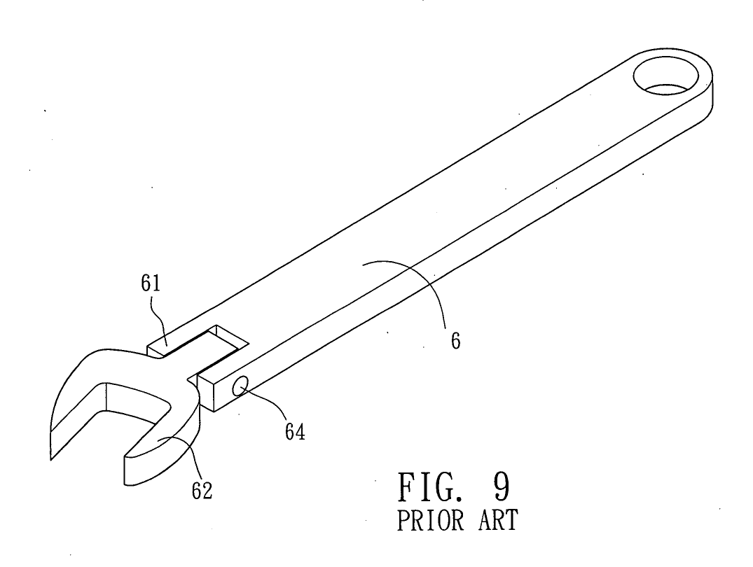

FIG. 10 is a schematic view showing the relation between the open-end wrench and a locking member of the prior art.

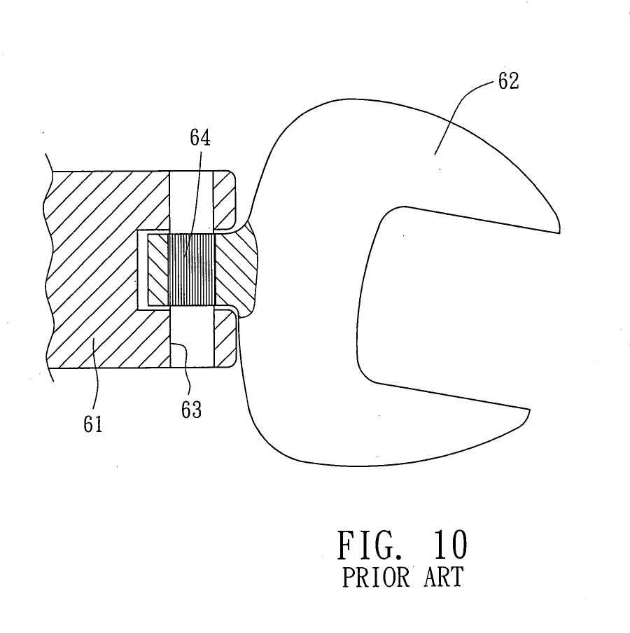

FIG. 11 is a schematic view showing an appearance of a socket wrench of the prior art.

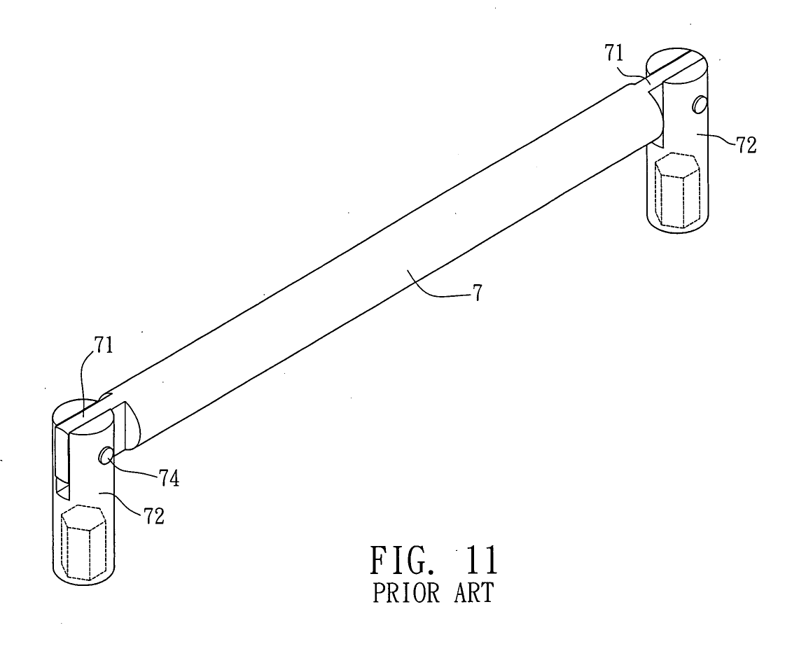

FIG. 12 is a schematic view showing the relation between a locking member and a pivoting hole of the socket wrench of the prior art.

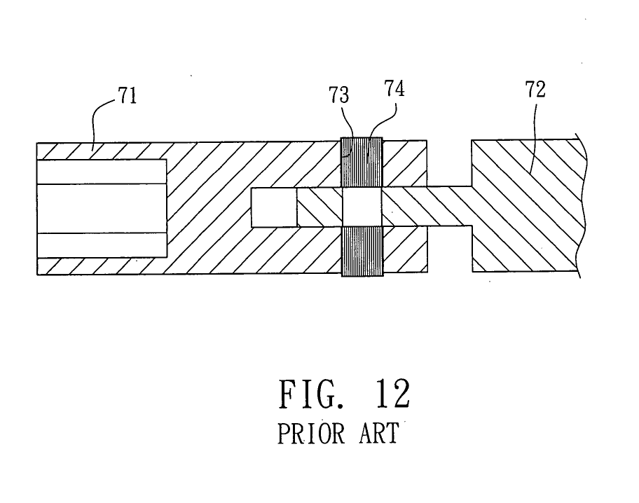

### DETAILED DESCRIPTION OF THE PREFERRED EMBODIMENTS

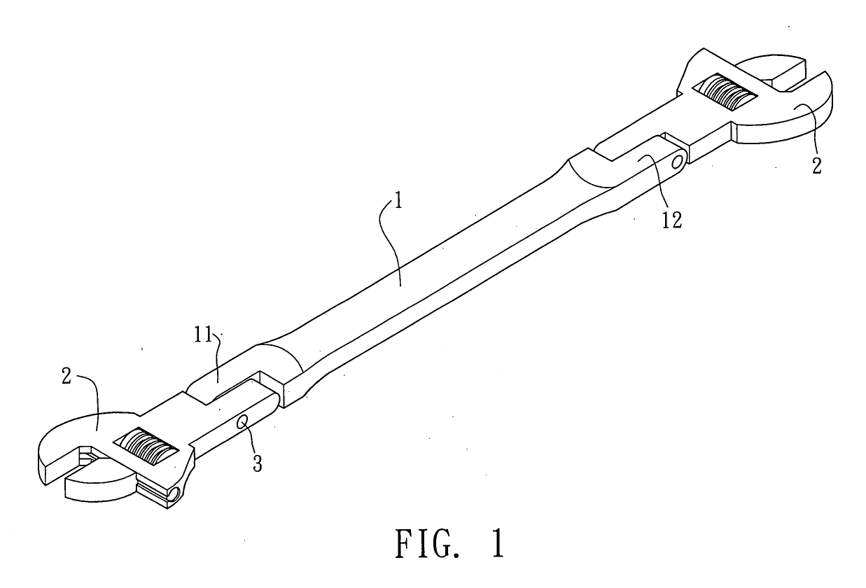

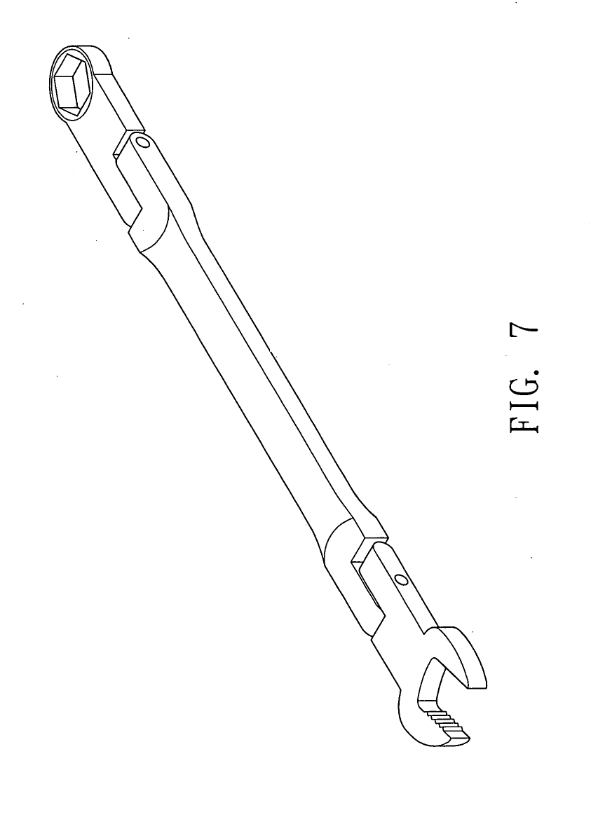

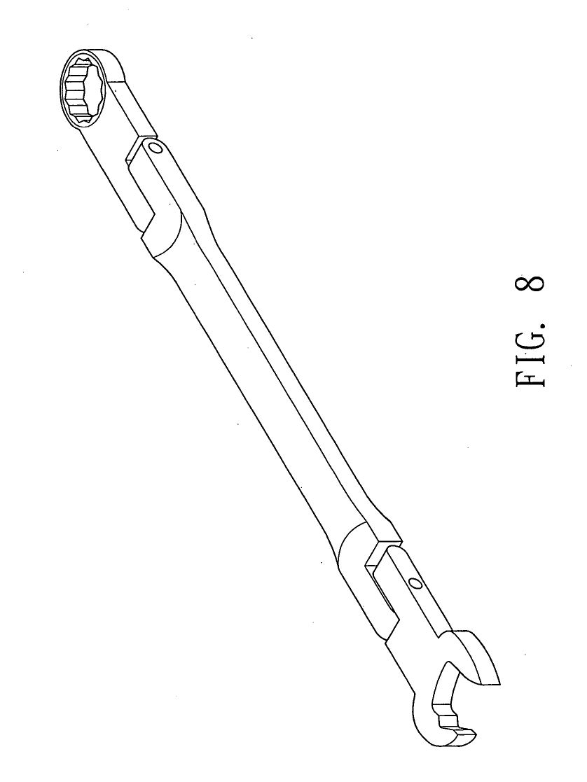

It can be first appreciate that those multiple preferred embodiment of the present invention as illustrated in FIGS. 1 through 8 are provided for describing the present invention and in no way restrict those claims to be made under this application.

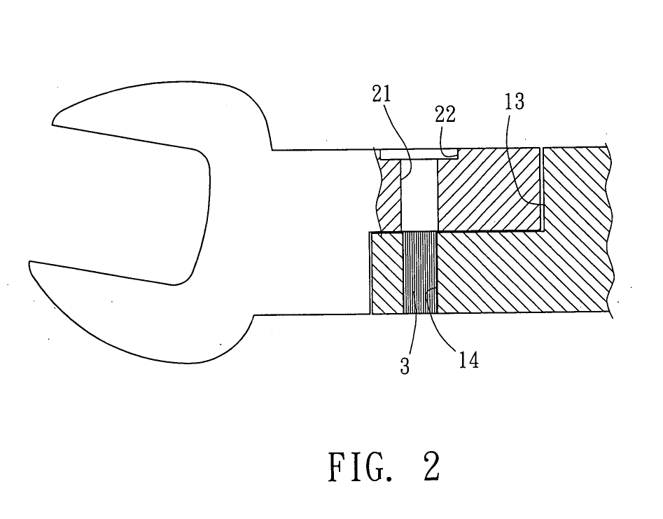

Referring to FIG. 1, a double head drive tool with each head serving as a moment of force for the other end is essentially comprised of a handle 1 of the drive tool, a first pivoting part 11 and a second pivoting part 12 are respectively provided to both ends of the handle 1. Both pivoting parts 11, 12 respectively extend a connection section 13. Each connection section 13 is connected with a work piece turning member 2. Each work piece turning member 2 is provided with a locking channel 22 and a longitudinal through hole 21. A work hole 14 is each provided on the pivoting parts 11, 12 of the handle 1. In the first preferred embodiment of the present invention, the work hole is processed to slightly indicate conic shape. The work hole 14 and the through hole 21 are respectively matching a serrated locking member 3 provided with a root with protruding round shape as illustrated in FIG. 2 for the locking member 3 to lock the work piece turning member 2 via the work hole 14 and the through hole 21. In the first preferred embodiment, the work piece turning member 2 relates to an adjustable wrench.

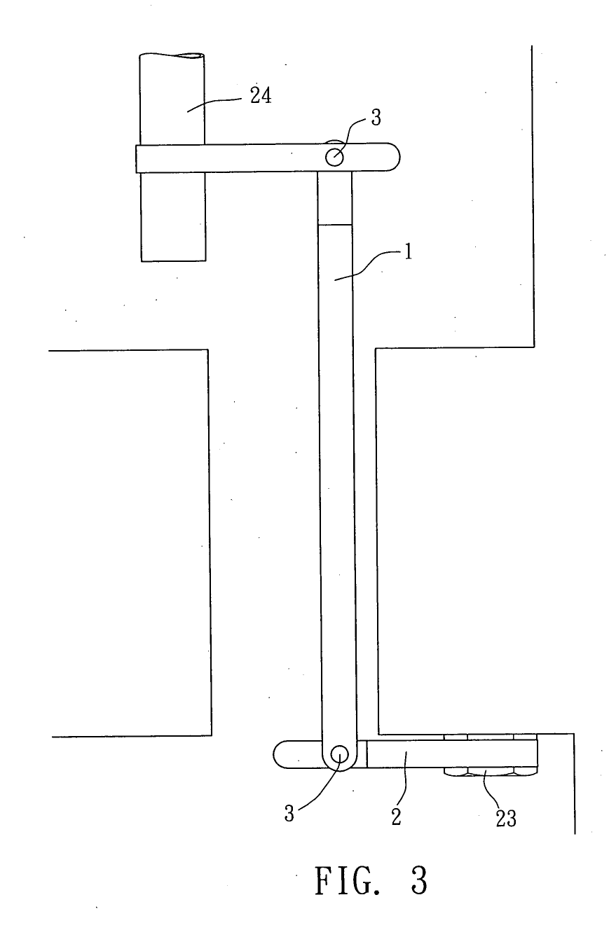

When used in a confined space, the adjustable wrench is adjustable to compromise the size of a nut 23 to be turned. The handle 1 of the drive tool is turned so that it is vertical to the first pivoting part 11, and then the second pivoting part 12 is turned to drive the nut 23. Meanwhile, another adjustable wrench of the second pivoting part 12 is inserted with a rod 24 to provide function of a pillar of force thus to yield good workability and practicability by the present invention as illustrated in FIG. 3.

When the handle 1 of the drive tool of the present invention operates the adjustable wrench adapted to the connection section 13 to drive the nut 23, the area between the adjustable wrench and the locking member 3 is under extreme force. The longitudinal through hole 21 of the present invention is engaged to a smooth middle section of the locking member 3 and the locking force exercised by the locking member 3 are sufficient to prevent the area between the adjustable wrench and the locking member 3 from deformation or damage due to the force externally applied.

Furthermore, with the work hole 14 being processed to slightly indicate conic shape and the root of the locking member 3 indicating protruding round shape and being serrated, the locking member of the present invention can be easily mounted into the work hole 14 and the abnormal tear and wear on the pivoting hole due to the serrated locking member penetrate through as observed with the single rock arm drive tool of the prior art is eliminated.

The present invention provides the following advantages:
1. Workable in confined space;
2. Avoid deformation and damage between the work piece turning member and the locking member; and
3. Avoid tear and wear on the pivoting part when the locking member penetrates through the work hole on the pivoting part.

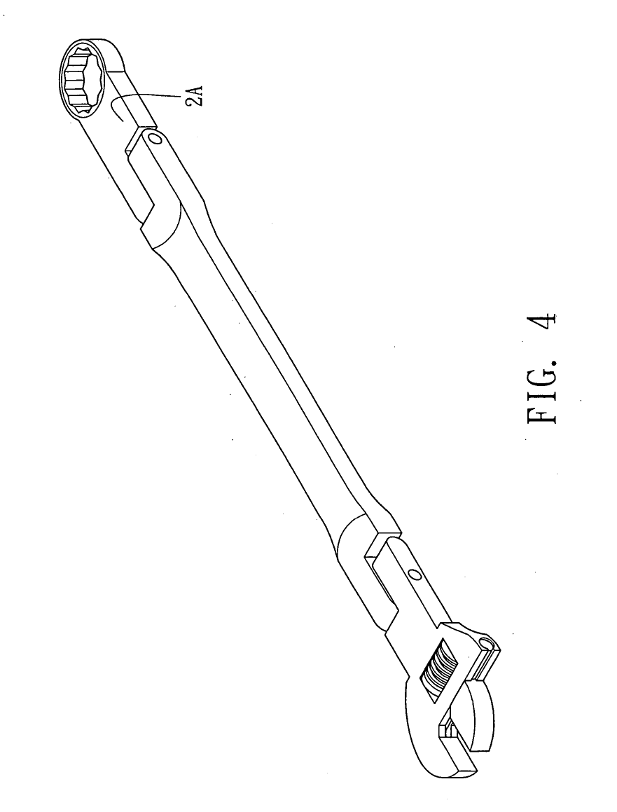

Now referring to FIG. 4 for a second preferred embodiment of the present invention, the work piece turning member 2A relates to a ratchet spanner to achieve the same purpose sought by the present invention.

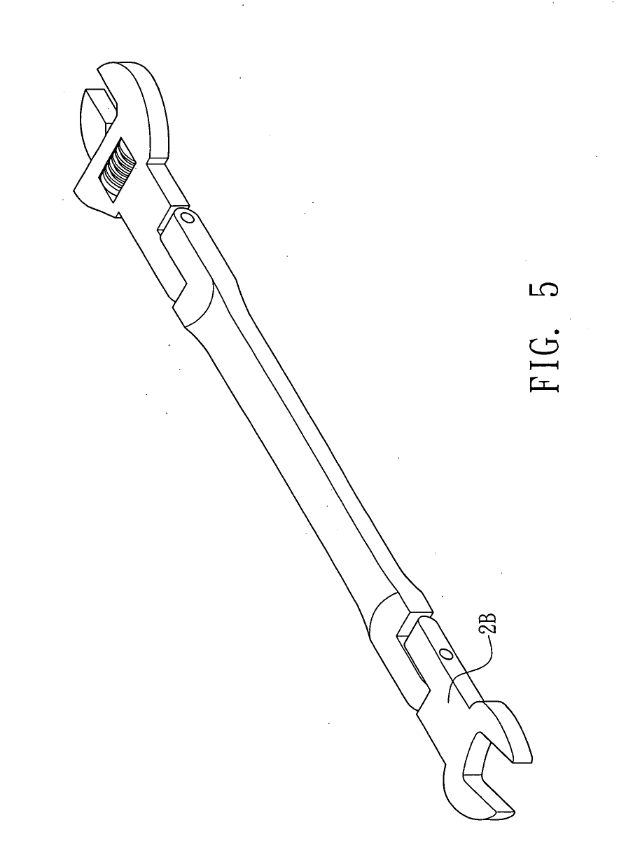

As illustrated in FIG. 5, the work piece turning member 2B in a third preferred embodiment of the present invention relates to an open-end wrench to achieve the same purpose sought by the present invention.

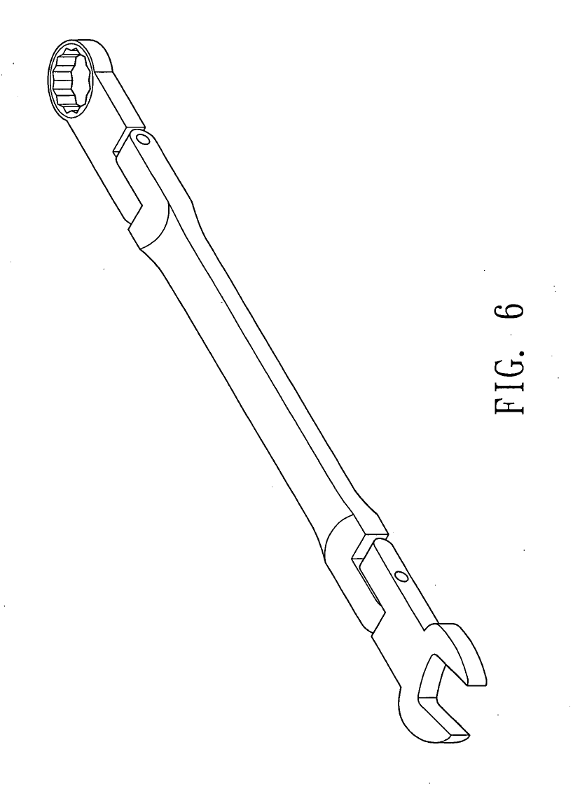

Of course, by only changing certain details, there are many other preferred embodiments of the present invention. For example, the combination of any two items of adjustable wrench, ratchet spanner, open-end wrench, flare nut spanner, ratchet ring spanner, and fast spanner for the present invention to be available in multiple combinations without additional members as illustrated in FIGS. 6, 7, and 8.

I claim,

1. A double head drive tool with each head serving as a moment of force for the other end includes a handle having its both ends respectively provided with a pivoting part; each pivoting part being extended a connection section; each connection section being adapted with a work piece turning member; a locking channel and a longitudinal being provided to the work piece turning member; a work hole being provided on the pivoting part of the handle of the drive tool; and a locking member penetrating the work hole and the through hole to lock the work piece turning member.

2. The double head drive tool of claim 1, wherein the interior of the work hole slightly indicates a conic shape and coupled to a serrated locking member having its root indicating a projecting round shape and a smooth middle section; and the locking member locks the work piece turning member through the work hole.

3. The double head drive tool of claim 1, wherein the work piece turning member relates to an adjustable open-end wrench.

4. The double head drive tool of claim 1, wherein the work piece turning member relates to a ratchet spanner.

5. The double head drive tool of claim 1, wherein the work piece turning member relates to an open-end wrench.

6. The double head drive tool of claim 1, wherein the work piece turning member relates to a fast spanner.

7. The double head drive tool of claim 1, wherein the work piece turning member related to a ratchet ring spanner.

8. The double head drive tool of claim 1, wherein the work piece member relates to a flare nut spanner.

9. The double head drive tool of claim 1, wherein the work piece turning member relates to a combination of any two items selected from an adjustable spanner, ratchet spanner, open-end wrench, fast spanner, ratchet ring spanner, and flare nut spanner depending on the use.
